(19) United States
(12) Patent Application Publication
(10) Pub. No.: US 2012/0322411 A1
(43) Pub. Date: Dec. 20, 2012

(54) METHOD AND SYSTEM FOR EVENT MANAGEMENT

(75) Inventors: Ivan Lazarev, Potomac, MD (US); Neil H. Pickard, Sandy, UT (US)

(73) Assignee: ITN International, Inc., Bethesda, MD (US)

(21) Appl. No.: 13/527,907

(22) Filed: Jun. 20, 2012

Related U.S. Application Data
(60) Provisional application No. 61/499,000, filed on Jun. 20, 2011.

(51) Int. Cl. H04W 12/06; H04W 60/00

(52) U.S. Cl. 455/411; 455/435.1

(57) ABSTRACT

An approach for providing event management is disclosed. A near field communication (NFC) mobile communication device may be linked to a predetermined event. A NFC transmission from the NFC mobile communication device may also be received. A user of the mobile communication device may further be registered to the event.

### RELATED APPLICATIONS

This application claims the benefit of the earlier filing date of U.S. Provisional Application Ser. No. 61/499,000 filed Jun. 20, 2011, entitled “Method and System for Event Management,” the entirety of which is incorporated herein by reference.

### BACKGROUND INFORMATION

Mobile communication devices, such as cellular telephones, laptop computers, pagers, personal digital assistants (PDAs), and the like currently serve a diversity of purposes. In addition to basic communications, mobile devices are used, for example, to conduct business transactions, and to manage entertainment media. Enhancements, such as location-awareness features, e.g., global positioning system (GPS) tracking, also enable mobile device users to provide unique location-based services. Various new application environments, in which the versatility of mobile communication devices can be used, can continue to be explored with various degrees of success.

Traditionally, these technological advances have not been widely deployed in management of information associated with large events or meetings, such as a convention or exhibition. Such gatherings can involve the exchange of a tremendous amount of information among participants and event sponsors. Unfortunately, the exchange is largely manual in nature, executed through the use of paper forms, distribution of brochures and business cards, etc.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of system for event management, according to one embodiment;

FIGS. 2A and 2B are diagrams, respectively, of functional electrical components of a near field communication (NFC) badge and representations that may be produced on the face of an NFC badge, according to various embodiments;

FIG. 3 is a flowchart of a process for registering participants in an event, according to one embodiment;

FIG. 4 is a flowchart of a process for management of access to an event and tracking data associated with the access to the event, according to one embodiment;

FIG. 5 is a diagram of a computer system that can be used to implement various exemplary elements of the event management system; and

FIG. 6 is a diagram of a chip set that can be used to implement an embodiment of the invention.

### DESCRIPTION OF THE PREFERRED EMBODIMENT

A system, method and software for providing event management are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

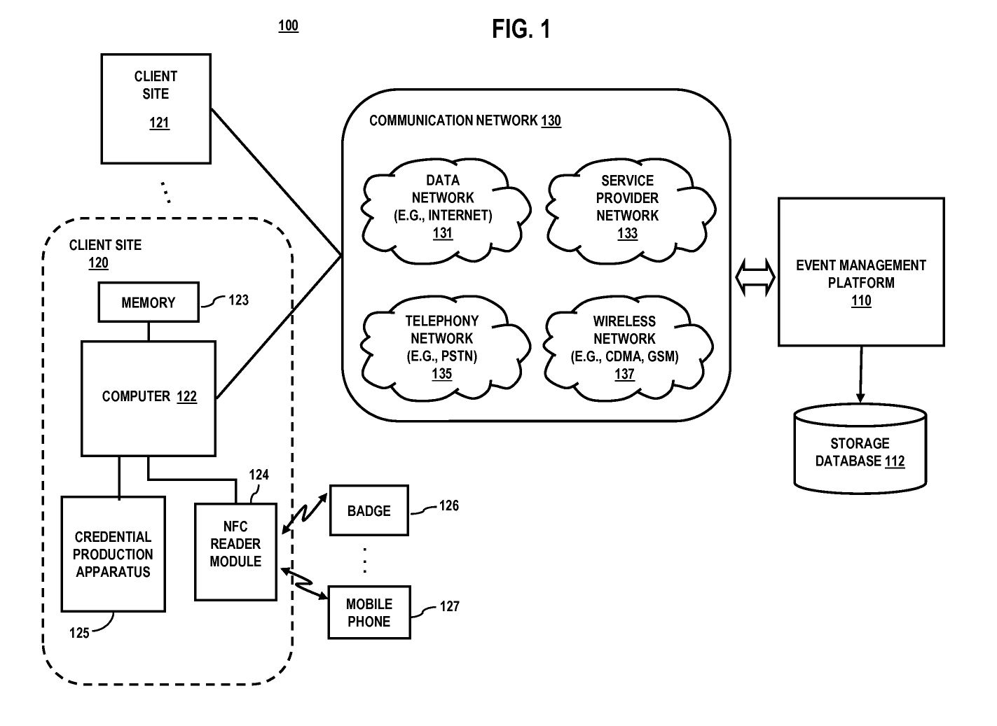

FIG. 1 is a diagram of system for event management, according to an exemplary embodiment. An event management system 100 is exemplified by FIG. 1 for the purposes of illustration. It is recognized that a need exists for a cost-efficient, convenient, and technologically robust approach to event management. Such technology development may employ, for instance, web-enabled, contact-less, open source technology to enable real time data collection at the event location. Also, the data can readily export the collected data to a repository for account management of event participants. Event management can further be expanded to be applicable to a plurality of event sites and to participants located remotely from an event site. The system 100, according to certain embodiments, addresses this need, as detailed below.

Under the scenario of FIG. 1, a mobile communication device includes near field communication (NFC) capability to facilitate the exchange of information for a user at an event. The event may take place at one or more client sites. The user, who may be an exhibitor, sponsor, or attendee, can be registered prior to or during the event for participation in the event. User information is entered into the user's mobile communication device for storage therein. The stored information may contain secured user credential data, including a password and a user identifier, as well as other information that can be used to maintain a user account record. The user and the mobile communication device are thus linked to the event based on the registration for the event.

One challenge with event management is to maximize effectiveness in meeting the needs of those who produce, promote, and participate in events, such as meetings, conferences, and exhibitions. Such events, which often are based at a registration site, should provide a satisfying experience for all users including, for example, the exhibitors, sponsors, and attendees. It is recognized that the use of wireless technology by system 100 throughout an event site can assist with addressing this challenge.

The system 100 includes an event management platform 110, which may be implemented as service provider server, for linking with client event sites, such as illustrated sites 120 and 121, via communication network 130. Platform 110 is coupled to storage 112 that can serve as a repository for client and user data stored in database format. It is contemplated that the event management platform 110 may also be a third party service provider (e.g., instead of the service provider associated with network 133).

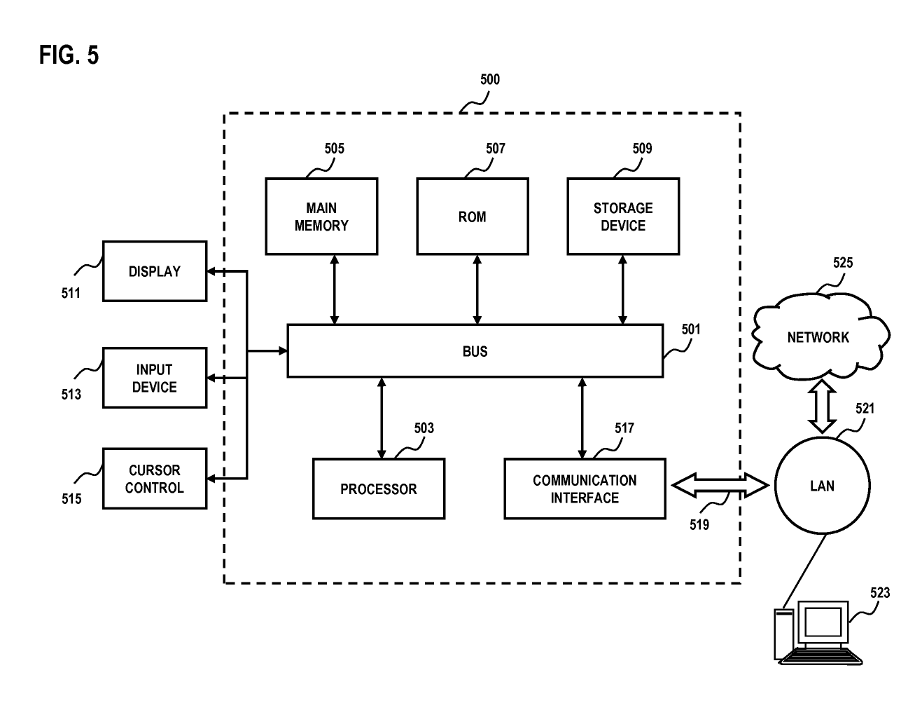

Exemplary client on-site equipment is illustrated for client site 120. Computer 122 is coupled to memory 123, which can be used to store client and user data associated with the site event. Near field communication (NFC) reader module 124 and credential production apparatus 125 are coupled to, and under the control of, computer 122. Credential production apparatus 125 is provided at the event site for convenient creation of participant badges, such as badge 126, for individuals who seek access to the event before or during the event occurrence. Credential production apparatus 125 contains appropriate processing and NFC capability for interaction with computer 122 and for encoding badges. Credential production apparatus 125 additionally includes one or more printing devices for forming images on a face of badge 126. Typical computing and processing hardware that may be utilized for operation of computer 122 and platform 110 and other processing devices are illustrated in FIG. 5, to be described more fully hereinafter.

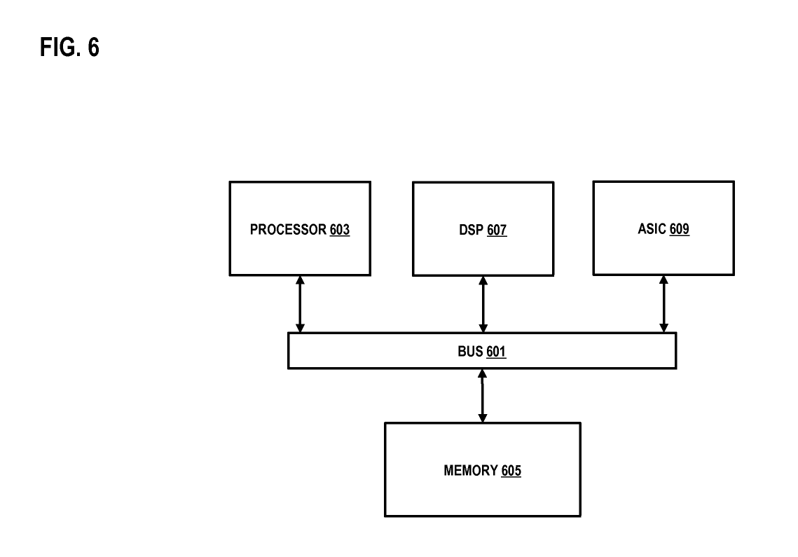

NFC capability may be embedded in mobile communication devices, such as mobile telephones and NFC badges. The term “badge” may be understood to exemplify any chip (e.g., chip of FIG. 6), smart card, transponder, contactless card, near field communication (NFC) tag, radio frequency identification (RFID) tag, or the like. NFC badges include processing capability and storage, and are configured with transceivers for interactive communication with NFC readers. An NFC reader can sense proximity of an NFC badge or NFC phone at the event location and, in response thereto, may authorize the user access to the event. The NFC reader can be linked to storage at the event site (e.g., sites 120, 121, etc.) or to a remote service provider site through a communication network 130. A near field communication session between the mobile communication device 127 and the reader can update user information stored by both the mobile communication device 127 and the remote server. Subsequent updating of user information can be performed in this manner.

NFC badges may be formed by credential production apparatus located at the event site. Incorporated into an NFC badge, for example, are a radio-frequency identification (RFID) integrated circuit, an antenna, and memory. A processor coupled to the credential production apparatus is configured to generate encoded user information for entry into the memory of the NFC badge. The credential production apparatus initially writes user credential information into the badge memory, thereby linking the badge to the event. This information is used, for instance, by an NFC reader to register a badge and user for participation in the event in response to receipt of an NFC communication from the badge by the NFC reader. The credential production apparatus can print user information including, for example, user photograph, graphic representations, and text information, on a face of the NFC badge.

The client event site processor can transmit generated user information to the remote server for input to a user database in server storage. As new user credential information is obtained, through NFC communication with new user devices, the server database can be updated. The server can maintain a plurality of such databases related to different client events. Such events may occur at different sites or times for a single client. One or more databases may be established respectively for the different clients. The event site processor can produce real-time reports regarding mobile devices that are registered during an event.

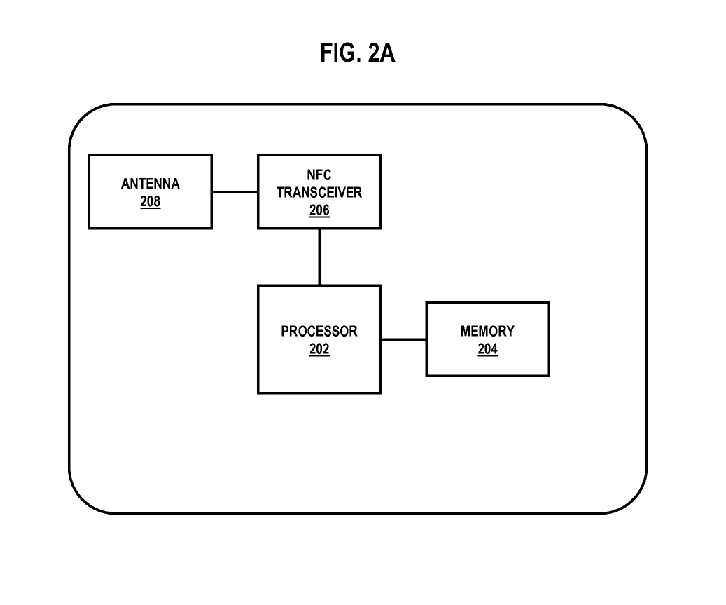

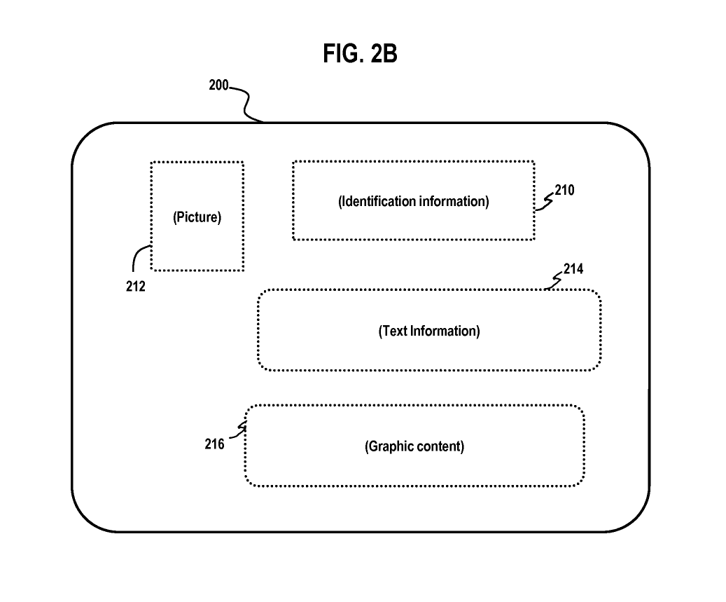

In certain embodiments, NFC capability can be implemented in mobile devices, such as badge 126 and mobile phone 127, which can communicate with NFC reader module 124 simply by being placed in the immediate vicinity thereof. The term “badge” may be understood to exemplify any chip, smart card, transponder, contactless card, near field communication (NFC) tag, radio frequency identification (RFID) tag, or the like. An exemplary badge 126 is described more fully below with respect to FIGS. 2A and 2B. Badge 126 may be produced by credential production apparatus 125, under control of computer 122. NFC communications between mobile communication devices and the NFC reader 124 form data transactions that can be collected in real time in memory 123 via computer 122. The data, as collected, can be updated to platform 110 for storage in database 112. Badge credentials can be used via NFC “contact-less” technology to register visits, conduct transactions and engage attendees at face-to-face events. The server can receive inquiries for database information from clients, to whom secured access can be provided.

As illustrated, communication network 130 encompasses one or more networks (e.g., data network 131, service provider network 133, telephony network 135, and wireless network 137). Network may be any suitable wireline and/or wireless network. For example, data network 131 may be any local area network (LAN), metropolitan area network (MAN), wide area network (WAN), the Internet, or any other suitable packet-switched network, such as a commercially owned, proprietary packet-switched network having voice over internet protocol (VoIP) capabilities, e.g., a proprietary cable or fiber-optic network. Telephony network 135 may include a circuit-switched network, such as the public switched telephone network (PSTN), an integrated services digital network (ISDN), a private branch exchange (PBX), or other like network. Meanwhile, wireless network 137 may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, networks 131-137 may be completely or partially contained within one another, or may embody one or more of the aforementioned infrastructures. For instance, the communication network 130 and/or the service provider network 133 may embody circuit-switched and/or packet-switched networks that include facilities to provide for transport of circuit-switched and/or packet-based communications. Networks 131-137 may include components and facilities to provide for signaling and/or bearer communications between the various components or facilities of system 100.

FIG. 2A illustrates functional electrical components of a badge, such as badge 126, that may be produced by credential production apparatus 125. Embedded within badge 200 are processor 202, coupled to memory 204 and transceiver 206, and antenna 208. Processor 202, memory 204 and transceiver 206 may be embodied in an integrated circuit chip. Credential production apparatus 125, under control of computer 122, can encode into badge memory 204 the user's contact and registration information, demographic codes. Processor 202 can modulate and demodulate near field signals communicated between antenna 208 and card reader 124 to provide interactive information exchange. Data can be transmitted from badge 126 to NFC reader module 124, stored in site memory 123, and then uploaded to platform 110. Data can be transmitted from the NFC reader module 124, or another NFC mobile communication device, to badge 126 for storage in its memory 204. Reading from and writing to memory 204 can take place virtually simultaneously.

FIG. 2B is an illustration of graphical and textual representations that may be printed on the face of NFC badge 200 by credential production apparatus 125. Credential production apparatus 125 may include plastic and paper badge printers for personalizing a face of the badge. The printer may be driven by computer 122 to print user identification 210 in upper and lower case in various printer fonts with font scalability and picture identification 212. Additional text information 214 and graphic content 216 can also be imprinted on the face of the badge for further personalization. For example, text information may be related to the user or use for advertising purposes. For heightened security, the badge may include a thumb print. The capacity of badge memory 204 may be more than sufficient to store data represented on the badge face, as well as other data formed in interactive communication. Although badge 200 is illustrated in the form of a card, the badge may be customized, for example, to take the form of extra large plastic credentials, wristbands, key fobs, or adhesive labels attached to displays or products.

The ability to read and encode the badge or other mobile NFC communication device affords several advantages. The system can provide real time reporting on how many people have picked up credentials. The system can provide real time reporting on how many people are currently participating in a given event session. User information can be used for real time lead distribution and follow-up. Also, announcements can be disseminated in real-time—e.g., if prize drawings are conducted at the event, prize winners can thus be announced in real time. Furthermore, lost or stolen badges can be immediately deactivated.

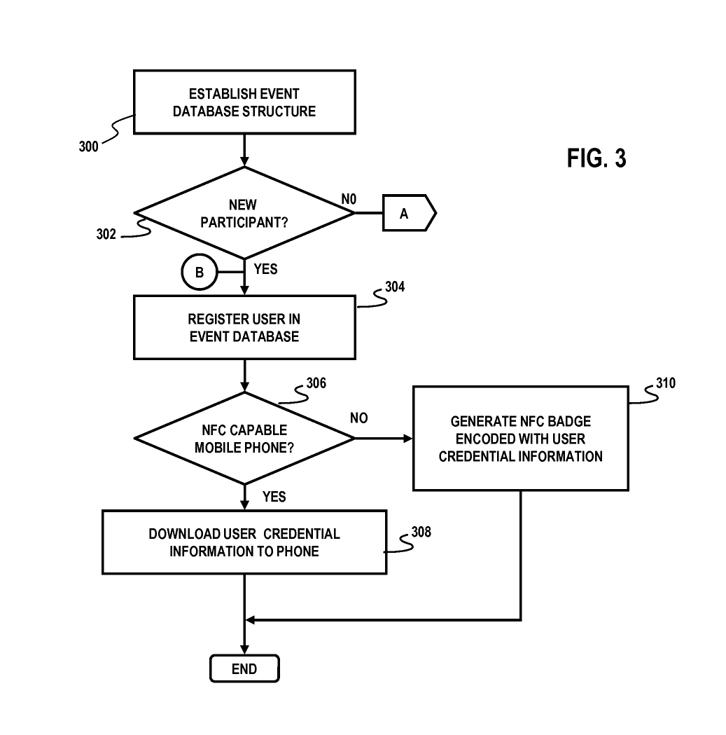

FIG. 3 is a flowchart of a process for registering participants in an event. At step 300, a database structure is established for managing a new event to occur at a specified time or time period. The event may encompass one or a plurality of sessions. The database structure can be stored at the server storage 112. The database will be populated with data for participants associated with the event, such as exhibitors, sponsors and attendees. Some of this data may be accumulated by communication via network 130 before user registration commences. As participants register for the event, data can be collected at the client event site and stored in memory 123. Event data can be exchanged between site memory 123 and server storage 112 as needed to maintain updating at both locations.

At step 302, determination is made as to whether a new participant is to be added to the event database. This determination may be triggered by request from an individual at the event site or by a request received by communication from a remote location. The request at the event site may take the form of an NFC communication from a mobile device of a user who may have been associated previously with the client. If determination is made at step 302 that the requestor seeking participation in the event is new to the event, registration processing takes place at step 304. Pertinent information for the registrant is obtained and, if appropriate, entered in the event database at the event site memory 123 and server storage 112.

To gain secured access to the event, the registrant must communicate via near field communication with an NFC reader module 124 under management by computer 122. In addition to granting access, computer 122 will store obtained data in memory 123. This data can be used for real time reporting as needed by the client. At step 306, determination is made as to whether the registrant is in possession of a mobile phone or similar mobile communication device having NFC capability. If so, at step 308, secure encoded user credential information is input to the user's device, for example, by direct NFC communication through NFC reader module 124, or through a transmission downloaded via communication network 130. The registration process is thus completed and the mobile device can then be used to gain access to the event. Should the mobile device be lost or stolen thereafter, communication by the user to the client will result in deregistration for the device.

If the registrant is not in possession of a mobile phone or similar mobile communication device having NFC capability, as determined in step 306, a badge 200 is generated, at step 310, by credential production apparatus 125, or by another such apparatus at a client or server site. The badge is encoded with user credential information. Additional information of interest can be included. Textual and/or graphic representations can be printed on a face of the badge. The registration process is thus completed and the badge can then be used to gain access to the event. Should the badge be lost or stolen thereafter, communication by the user to the client will effect deregistration for the device. A new badge for the user can then be provided by credential production apparatus 125.

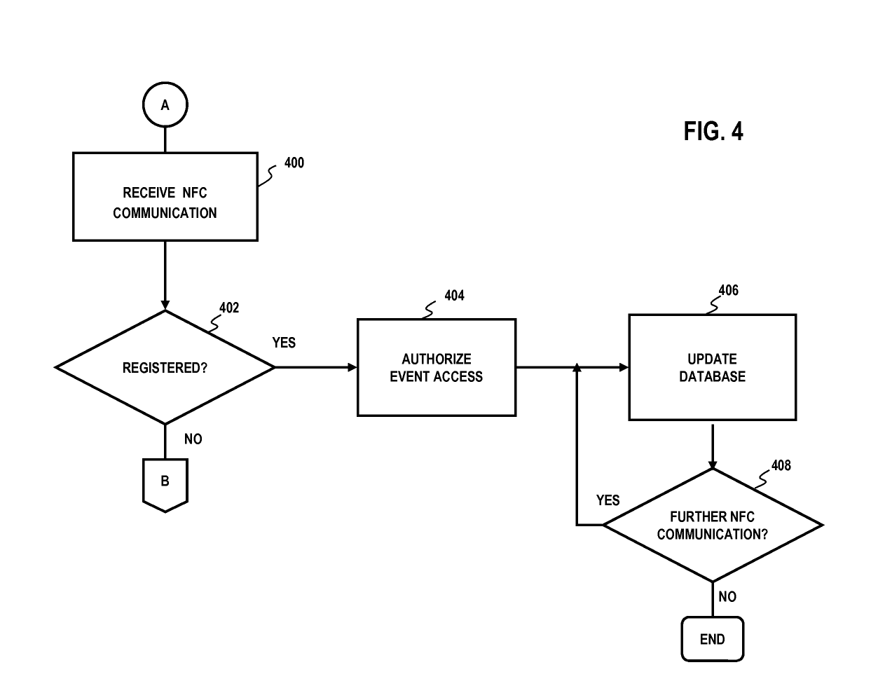

If it is determined at step 302 that an NFC communication has been received from a device that does not represent a new participant in the event, the process proceeds to step 400 in FIG. 4. FIG. 4 is a flowchart of a process for management of access to an event, and tracking data associated with the access to the event, for event registrants. At step 400, an NFC communication is received by NFC reader 124 at the event site. In order for the user to gain access to the event, computer 122 determines, at step 402, whether a valid user credential has been presented, e.g., whether the NFC device has been registered. If not, the process reverts to step 304, of FIG. 3 for appropriate registration of the NFC device. If it is determined at step 402 that the NFC device contains valid credential data, access to the event by the user is authorized. During the NFC authorization step 404, data is exchanged between the user's mobile NFC device and the NFC reader module 124. Upon authorization, a communication session (e.g., between the mobile NFC device and the NFC reader module 124) may then exist to allow for an exchange of additional information. This information is entered in site memory 123 to update the database and uploaded either currently, or at a future time, to server storage 112 via communication network 130. During an event session, further NFC communication can take place, at either the user or client initiation, at step 408, with appropriate updating of databases at step 406.

The processes described herein for providing event management may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to one embodiment, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 either use electrical, electromagnetic or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 6 illustrates a chip set or chip 600 upon which an embodiment of the invention may be implemented. Chip set 600 is programmed to authenticate respective members engaged in a web-based transaction without compromising the integrity or anonymity of respective members as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of authenticating respective members engaged in a web-based transaction without compromising the integrity or anonymity of respective members.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to authenticate respective members engaged in a web-based transaction without compromising the integrity or anonymity of respective members. The memory 605 also stores the data associated with or generated from execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
linking a near field communication (NFC) mobile communication device to a predetermined event;
receiving a NFC transmission from the NFC mobile communication device; and
registering a user of the mobile communication device to the event.

2. A method as recited in claim 1, wherein the step of linking comprises:
generating an NFC badge;
formulating credential information corresponding to the user; and
storing the credential information in the NFC badge.

3. A method as recited in claim 2, wherein the stored credential information comprises an encoded secure password.

4. A method as recited in claim 2, wherein the NFC badge is configured with a transceiver for interactive data communication, and further comprising conducting a NFC communication to update the credential information stored in the NFC badge.

5. A method as recited in claim 2, wherein the event comprises user participation at an event location, and the step of receiving comprises sensing proximity of the NFC badge at the event location.

6. A method as recited in claim 5, wherein the step of linking further comprises:
transmitting the credential information to a site remote from the event location; and
storing the transmitted credential information at the remote site.

7. A method as recited in claim 1, wherein the step of linking comprises communicating with a mobile telephone.

8. A method as recited in claim 7, wherein the step of communicating comprises conducting an NFC session at an event location.

9. A method as recited in claim 8, wherein the step of linking further comprises:
transmitting user credential information to a site remote from the event location; and
storing the user credential information at the remote site.

10. A method as recited in claim 9, further comprising:
conducting a transaction session with the mobile telephone; and
updating the stored user credential information in accordance with the transaction session.

11. A method as recited in claim 7, wherein the step of communicating comprises transmitting secure password information.

12. A method comprising:
registering a user to participate in a scheduled event prior to the event;
inputting information to a mobile communication device of the user;
receiving a near field communication (NFC) from the mobile communication device; and
authorizing the user access to the event in response to receipt of the NFC.

13. A method as recited in claim 12, wherein the near field communication is received at an event location.

14. A method as recited in claim 12, wherein the step of inputting comprises entering user credential information.

15. A method as recited in claim 14, wherein the user credential information comprises an encoded password.

16. A method as recited in claim 14, further comprising:
conducting an NFC communication session with the mobile communication device at the event location; and
updating the stored user credential information in accordance with the NFC communication session.

17. A method as recited in claim 16, further comprising:
transmitting the user credential information to a site remote from the event location; and
storing the user credential information at the remote site.

18. A method as recited in claim 12, wherein the step of registering comprises issuing an NFC badge linking the user to the event; and
the step of inputting comprises encoding information corresponding to the user and storing the encoded information in the NFC badge.

19. A method as recited in claim 18, further comprising updating information stored in the NFC badge.

20. A method as recited in claim 19, wherein in the step of updating comprises conducting an interactive NFC communication session with the NFC badge at the event site.

21. A system comprising:
a server located at a service provider site, the server coupled through a network to a client site, the client site comprising:
a processor;
credential production apparatus configured to generate a near field communication (NFC) badge under control of the processor, the NFC badge linked to a client managed event;
an NFC reader coupled to the processor; wherein
the NFC reader is configured for interactive NFC communication with NFC mobile communication devices; and
the processor is configured to register a user of a mobile communication device to participate in the event in response to receipt of an NFC communication by the NFC reader.

22. A system as recited in claim 21, wherein the NFC badge comprises:
a radio-frequency identification (RFID) integrated circuit;
an antenna; and
memory, wherein the credential production apparatus is configured to write user credential information into the memory.

23. The system as recited in claim 22, wherein the credential production apparatus is configured to print user information on a face of the NFC badge.

24. A system as recited in claim 22, wherein the processor is configured to generate encoded user information and the credential production apparatus is configured to enter the encoded user information generated by the processor into the memory in the NFC badge.

25. A system as recited in claim 21, wherein the mobile communication device comprises the NFC badge.

26. A system as recited in claim 21, wherein the mobile communication device comprises a mobile telephone.

27. A system as recited in claim 21, the server comprises memory storage;
the processor is configured to generate user credential information for NFC communication sessions between the NFC reader and mobile communication devices, and to transmit the generated user credential information to the server; and
the server is configured to maintain a user credential database for user credentials in the memory storage.

28. A system as recited in claim 27, wherein the processor is configured to obtain new user credential information and the server is configured to update the user credential database based on the new user credential information.

29. A system as recited in claim 28, wherein the new user credential information is obtained in accordance with a further NFC communication session.

30. A system as recited in claim 29, wherein the further NFC communication session comprises transmission with the NFC badge, and the NFC reader is configured to update the user credential information in the NFC badge.

31. A system as recited in claim 21, wherein the server is coupled to a plurality of client sites, each site associated with a respective event, and the server is configured to maintain user credential databases in the memory storage associated respectively with the plurality of client sites.

32. A system as recited in claim 21, wherein the processor is configured to produce a real time report regarding mobile devices that are registered during the event.
